(19) United States
(12) Patent Application Publication
(10) Pub. No.: US 2013/0130708 A1
(43) Pub. Date: May 23, 2013

(54) WIRELESS REGULATORY COMPLIANCE BASED ON PHYSICAL LOCATION

(71) Applicants: Harshal S. CHHAYA, Plano, TX (US); Ariton E. XHAFA, Plano, TX (US)

(72) Inventors: Harshal S. CHHAYA, Plano, TX (US); Ariton E. XHAFA, Plano, TX (US)

(73) Assignee: TEXAS INSTRUMENTS INCORPORATED, Dallas, TX (US)

(21) Appl. No.: 13/298,731

(22) Filed: Nov. 17, 2011

(51) Int. Cl. H04W 24/00; H04W 74/04; H04W 92/00

(52) U.S. Cl. 455/456.1; 370/338

(57) ABSTRACT

A wireless device comprises a first medium access controller (MAC) configured to communicate in a first basic service set (BSS) via a first wireless network and logic coupled to said the MAC. The logic is configured to determine a physical location of the wireless device and implement a communication parameter based on the determined physical location. The communication parameter includes at least one of a frequency, a channel, transmit power, and dynamic frequency selection.

### BACKGROUND

The number of available consumer and mobile wireless devices based on the IEEE 802.11 wireless networking standards (i.e., WI-FI CERTIFIED devices) is increasing rapidly. Increasing adoption of IEEE 802.11 wireless networking standards in devices beyond personal computers and Access Points enables new usage models. For example, a user may desire to use his mobile handset to share, show, print, and/or synchronize content by connecting with other consumer electronics or a mobile handset of another user through IEEE 802.11 based technologies, regardless of infrastructure network availability.

To satisfy this need, peer-to-peer networking standards that employ IEEE 802.11 based networking are being developed. The WI-FI DIRECT standard promulgated by the WI-FI ALLIANCE is one such standard that allows consumer electronics, mobile handsets, etc. to connect and communicate in an ad-hoc and peer-to-peer fashion. Mobile devices can and are used in different countries that have different communication requirements.

### SUMMARY

Apparatus and methods for controlling a wireless device to configure one or more of its communication parameters based on its physical location. In some embodiments, a wireless device comprises a first medium access controller (MAC) configured to communicate in a first basic service set (BSS) via a first wireless network and logic coupled to said the MAC. The logic is configured to determine a physical location of the wireless device and implement a communication parameter based on the determined physical location. The communication parameter includes at least one of a frequency, a channel, transmit power, and dynamic frequency selection.

In other embodiments, a wireless device comprises a first MAC configured to communicate in a first BSS via a first wireless network, as well as logic coupled to the first MAC. The logic is configured to determine a physical location of the wireless device and implement a communication parameter based on the determined physical location. The logic determines the physical location based on at least one of a satellite-based receiver and time zone information.

Yet other embodiments are directed to a method for a wireless device. The method comprises determining, by logic in the wireless device, a physical location of the wireless device and determining a wireless configuration for the wireless device based on the physical location. The method further comprises configuring the wireless device based on the determined wireless configuration. The determined wireless configuration includes at least one of frequency, a channel, transmit power, and dynamic frequency selection.

### BRIEF DESCRIPTION OF THE DRAWINGS

For a detailed description of exemplary embodiments of the invention, reference will now be made to the accompanying drawings in which:

FIG. 1 shows a block diagram of a wireless device that may use physical location to configure its wireless communication parameters;

FIG. 2 shows a dual basic service set (BSS) wireless device concurrently operating in two IEEE 802.11 based wireless networks in accordance with various embodiments;

FIG. 3 shows a block diagram of a dual BSS wireless device using physical location to configure its communication parameters in accordance with various embodiments;

FIG. 4 shows exemplary message flow between a BSS scheduler, an active BSS medium access controller (MAC), and an inactive BSS MAC in a dual BSS wireless device in accordance with various embodiments;

FIG. 5 shows an exemplary view of MAC states in a dual BSS wireless device in accordance with various embodiments;

FIG. 6 shows a flow diagram for a method for responding to a dual BSS request message based on MAC state in accordance with various embodiments; and

FIG. 7 shows a flow diagram for a method for changing BSS activation states in a dual BSS wireless device in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

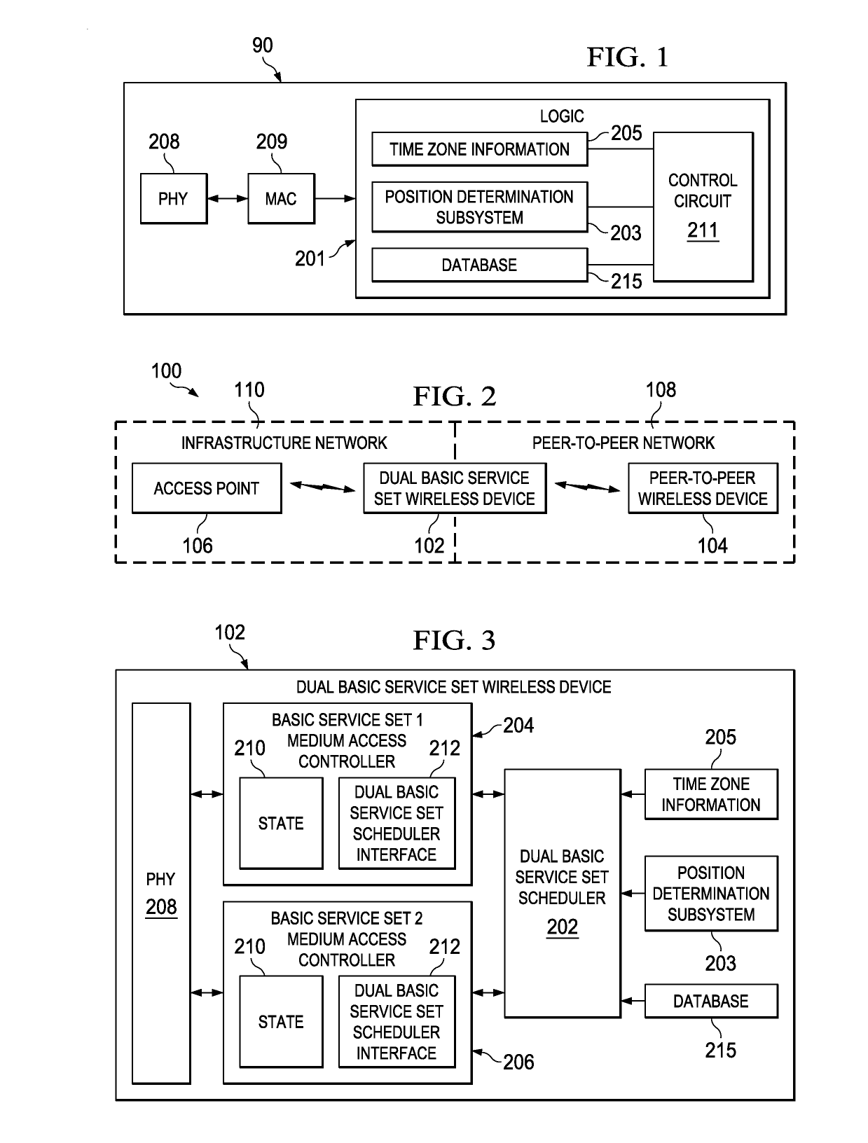

A wireless device in accordance with some embodiments configures itself for regulatory compliance based on its physical location. For example, FIG. 1 illustrates a wireless device 90 that includes a MAC 209 coupled to logic 201 and a PHY 208. The logic 201 includes either or both of a position determination subsystem (PDS) 203 and a time zone information (TZI) 205, as well as a database 215. Control circuit 211 is also included to interact with PDS 203, TZI 205 and database 215. The TZI 205 comprises information accessible to the device 102 by which the device is informed of the time zone in which it is currently located. Such information may be in the form of the number of hours different than Greenwich Mean Time (GMT), a textual identity of the time zone (e.g., “central daylight time”), or any other information from which the device 102 can determine or estimate its location. The PDS 203 preferably comprises a GPS receiver by which the device 102 can determine its location with a high degree of accuracy.

The database 215 includes information that cross-references locations to regulatory domains. In some embodiments, the database 215 may include a list of countries and, for each country, a list of the communication transmission requirements (see exemplary list above) required for each such country. In some embodiments, the database 215 may include a group of countries (e.g., a continent), and for each group, a list of the communication transmission requirements required for each such group.

For the wireless device 207 to operate in wireless network, the logic 201 (e.g., control circuit 211) preferably receives input from the PDS 203, if present, indicating the location of the device. The logic 201 then consults the database 215 and, based on the present location of the device, determines the communication parameters by which to configure the corresponding MAC 209 for operation in the network. In some embodiments, the database 215 comprises a look-up table that maps location to communication parameters required for the corresponding location. Once the logic 201 determines the location of the device and the appropriate communication parameters to implement given the regulatory domain in which the device is located, the logic 201 transmits a message to the MAC 209 to implement the correct communication parameters. In other embodiments, the logic 201 does not determine the location and, instead, commands the MAC 211 to determine the location based on input from the PDS 203 and configure the MAC for the correct regulatory domain. Which ever logic communicates with the PDS 203 to ascertain location information, that logic accesses the database 215 to determine the corresponding regulatory domain and/or communication parameters.

In yet other embodiments, when the wireless device 102 is being configured to operate in a wireless network, the logic responsible for determining location and programming the communication parameters for the regulatory domain in which the device is located, accesses the time zone information 205 and cross-references that information to the regulatory domain and communication parameters via database 215.

In some embodiments, the wireless device is capable of operating in an infrastructure network and in a peer-to-peer network. The following discussion pertains to a wireless device capable of operating in either of such networks. One technique for providing peer-to-peer networking between IEEE 802.11 compliant devices involves configuring a consumer or mobile device, e.g., via software, to operate as an access point. Such a device serves as group master providing functionality analogous to that of an access point in an infrastructure network. Other devices connect with the group master in the same or similar way that the devices would connect to a conventional access point.

Because such devices can operate as a group master in a peer-to-peer network and a wireless station in an infrastructure network, the device can concurrently operate and maintain connections in two distinct IEEE 802.11 based wireless networks. Each network connection of the device is referred to herein as a Basic Service Set (BSS). Accordingly, a device that maintains connections to two IEEE 802.11 based wireless networks, as described above, is a part of two BSSs and operates in dual BSS mode. As used herein, “dual BSS mode” refers to an operational state wherein a device is concurrently connected to more than one BSS. A device operating in dual BSS mode should efficiently manage when each BSS will access the wireless resources shared by the BSSs. Embodiments of the present disclosure employ time multiplexing, and medium access controller (MAC) state information to efficiently share the wireless resources.

Further, when the device is configured to operate in a peer-to-peer network, the device should determine in what regulatory domain the device is currently resident and implement the regulations required by that regulatory domain. A regulatory domain comprises a geographic region in which wireless communications are regulated by, for example, a government. In some examples, a regulatory domain may span the entire area of a given country. Each regulatory domain specifies one or more communication parameters that must be followed by any wireless devices being sold and operated in that domain. Examples of such communication parameters include one or more of the following:
The channels and frequencies on which communications may be conducted
The maximum transmit power on each channel
Various modulation schemes that are permitted (or banned)
Certain functions that can/must be performed such as dynamic frequency selection and transmit power control

In accordance with the preferred embodiments of the invention, when the device is configured to operate in a peer-to-peer network, the device determines the regulatory domain in which it is located and configures itself per the communication parameters required by the domain. In some embodiments, the device includes a position determination system such as a satellite-based receiver (e.g., Global Positioning System (GPS) receiver) to determine its location, and compares the location to a database in which locations can be cross-referenced to regulatory domains and/or the corresponding communication parameters for such regulatory domains. In other embodiments, the device determines/estimates its location from time zone information to which the device has access.

FIG. 2 shows a dual BSS wireless device 102 concurrently operating in two IEEE 802.11 based wireless networks in accordance with various embodiments. The wireless network 108 is a peer-to-peer network, e.g., a network compliant with the Wi-Fi Peer-to-Peer Specification promulgated by the WI-FI ALLIANCE. The dual BSS wireless device 102 communicates with the wireless device 104 using peer-to-peer protocols applicable to the wireless network 108. The dual BSS wireless device 102 may be the group master for the network 108, or alternatively, the wireless device 104 may be the group master for the network 108 and the dual BSS wireless device 102 may be a station connected to the group master.

The wireless network 110 may be an infrastructure-based wireless network or a second peer-to-peer network. An infrastructure network is a network through which wireless stations access the network via a dedicated access point. Accordingly, the infrastructure network 110 includes an access point 106 and the dual BSS wireless device 102 operates as a wireless station connected to the access point 106. In peer-to-peer networks, devices communicate directly with one another, rather than through a dedicated access point. Consequently, if the wireless network 110 is a peer-to-peer network, then the dedicated access point 106 is replaced by a peer-to-peer (P2P) wireless device configured to employ peer-to-peer protocols (e.g., an instance of the wireless device 104), and one of the dual BSS wireless device 102 and the P2P wireless device functions as the group master while the other device functions as a station connected to the group master.

The dual BSS wireless device 102 is configured to share wireless resources (e.g., PHY hardware, MAC hardware, communication medium access, etc.) across the networks 108, 110. Sharing is implemented using time multiplexing (i.e., time division multiple access, TDMA) in some embodiments of the dual BSS wireless device 102, wherein access to the wireless resources and communication medium alternates between the BSSs. A dual BSS time multiplexing algorithm executed by the dual BSS wireless device 102 will determine the length of time allocated to each BSS (i.e., BSS service time) and base this determination on a number of different factors. Some of these factors include the quality of service (QoS) requirements of each packet flow, packet traffic load, packet type, current data rates in use for each packet flow, power management status of the device 102, and a number of other characteristics of each flow and/or device within a BSS. A BSS enabled to access wireless resources is termed an “active BSS,” while a BSS not enabled to access wireless resources is termed an “inactive BSS.”

FIG. 3 shows a block diagram of the dual BSS wireless device 102 in accordance with various embodiments. The dual BSS wireless device 102 includes a dual BSS scheduler 202, a BSS 1 MAC 204, a BSS 2 MAC 206, and a PHY 208. The device 102 also includes either or both of the PDS 203 and the TZI 205, as well as the database 215.

The dual BSS scheduler 202 manages the access by MACs 204, 206 to the medium and other shared resources by sequentially activating and deactivating the MACs 204, 206. Each of the MACs 204, 206 perform the link layer operations required by the BSS to which the MAC is connected. For example, the BSS 1 MAC 204 may perform link layer operations for the BSS of the peer-to-peer network 108, and the BSS 2 MAC 206 may perform link layer operations for the BSS of the infrastructure network 110. In some embodiments of the wireless device 102, the MACs 204, 206 represent logical MACs that are connected to the respective BSSs while sharing access to physical MAC hardware resources. In such embodiments, the shared MAC hardware resource may be reconfigured to service the active BSS when the BSS is activated. The PHY 208 provides the electrical and physical interfaces between the device 102 and the wireless medium. In some embodiments, the PHY 208 and associated antennas are shared by the MACs 204, 206. Some embodiments of the dual BSS wireless device 102 may include more than one PHY 208. For example, each of the MACs 204, 206 may be coupled to a different PHY 208.

Each of the MACs 204, 206 include state storage 210 and a dual BSS scheduler interface 212. The state storage 210 stores the current state of the MAC for use in BSS state scheduling as explained below. The dual BSS state scheduler interface 212 interfaces with the dual BSS scheduler 202, and executes BSS state transition based on messages exchanged with the dual BSS scheduler 202 as described below. The dual BSS state schedule interface 212 may also implement a MAC Layer Management Entity (MLME) which is dynamically configured for the regulatory domain in which the device 102 is resident when the corresponding MAC 204, 206 is operating in a peer-to-peer network.

When the wireless device of FIG. 3 is being configured to operate in a peer-to-peer network, the device dual BSS scheduler 202 preferably receives input from the PDS 203, if present, indicating the location of the device. The dual BSS scheduler 202 then consults the database 215 and, based on the present location of the device, determines the communication parameters by which to configure the corresponding MAC 204, 206 for operation in the peer-to-peer network. In some embodiments, the database 215 comprises a look-up table that maps location to communication parameters required for the corresponding location. Once the dual BSS scheduler 202 determines the location of the device and the appropriate communication parameters to implement given the regulatory domain in which the device is located, the scheduler 202 transmits a message to the dual BSS scheduler interface 212 of the appropriate MAC 204, 206 to implement the correct communication parameters. In other embodiments, the dual BSS scheduler 202 does not determine the location and, instead, commands the dual BSS scheduler interface 212, or other logic internal or external to the MAC 204, 206, to determine the location based on input from the PDS 203 and configure the MAC for the correct regulatory domain. Which ever logic communicates with the PDS 203 to ascertain location information, that logic accesses the database 215 to determine the corresponding regulatory domain and/or communication parameters.

In yet other embodiments, when the device 102 is being configured to operate in a peer-to-peer network, the logic responsible for determining location and programming the communication parameters for the regulatory domain in which the device is located, accesses the time zone information 205 and cross-references that information to the regulatory domain and communication parameters via database 215.

The dual BSS scheduler 202 and the MACs 204, 206 communicate to implement a dual BSS control algorithm. The messages transferred between the dual BSS scheduler 202 and the MACs 204, 206 include a Dual BSS Request Message, a Dual BSS Response Message, and a Dual BSS Command Message. The Dual BSS Request Message is issued by the dual BSS scheduler 202 to a MAC 204, 206 requesting that the MAC transition from an active BSS state to an inactive BSS state. That is, the Dual BSS Request Message requests that the receiving MAC 204, 206 relinquish access to the wireless medium and other shared resources. In various embodiments of the wireless device 102, the Dual BSS Request Message is non-preemptive, indicating that a MAC 204, 206 receiving the message need not immediately transition to the inactive BSS state, but rather may transition to the inactive BSS state based on the state of the MAC 204, 206 when the message is received.

In reply to a received Dual BSS Request Message, a MAC 204, 206 issues a Dual BSS Response Message. The Dual BSS Response Message indicates to the dual BSS scheduler 202 that the MAC 204, 206 issuing the message has transitioned, or will transition, within a predetermined interval from an active BSS state to an inactive BSS state, thereby freeing shared wireless resources for use by a different BSS. In various embodiments of the wireless device 102, the Dual BSS Response Message is non-preemptive, indicating that the dual BSS scheduler 202 need not immediately act on the message when the message is received.

The Dual BSS Command Message is issued by the dual BSS scheduler 202 to require the receiving MAC 204, 206 to immediately change states. In some embodiments, the Dual BSS Command Message specifies the state to which the MAC 204, 206 should transition. In other embodiments, the Dual BSS Command Message specifies that the receiving MAC 204, 206 should immediately transition from its current state to another known state. For example, a receiving MAC 204, 206 in active BSS state should transition to inactive BSS state, and a receiving MAC 204, 206 in inactive BSS state should transition to active BSS state. In various embodiments of the wireless device 102, the Dual BSS Command Message is preemptive, indicating that the receiving MAC 204, 206 should immediately act on the message and change BSS states when the message is received.

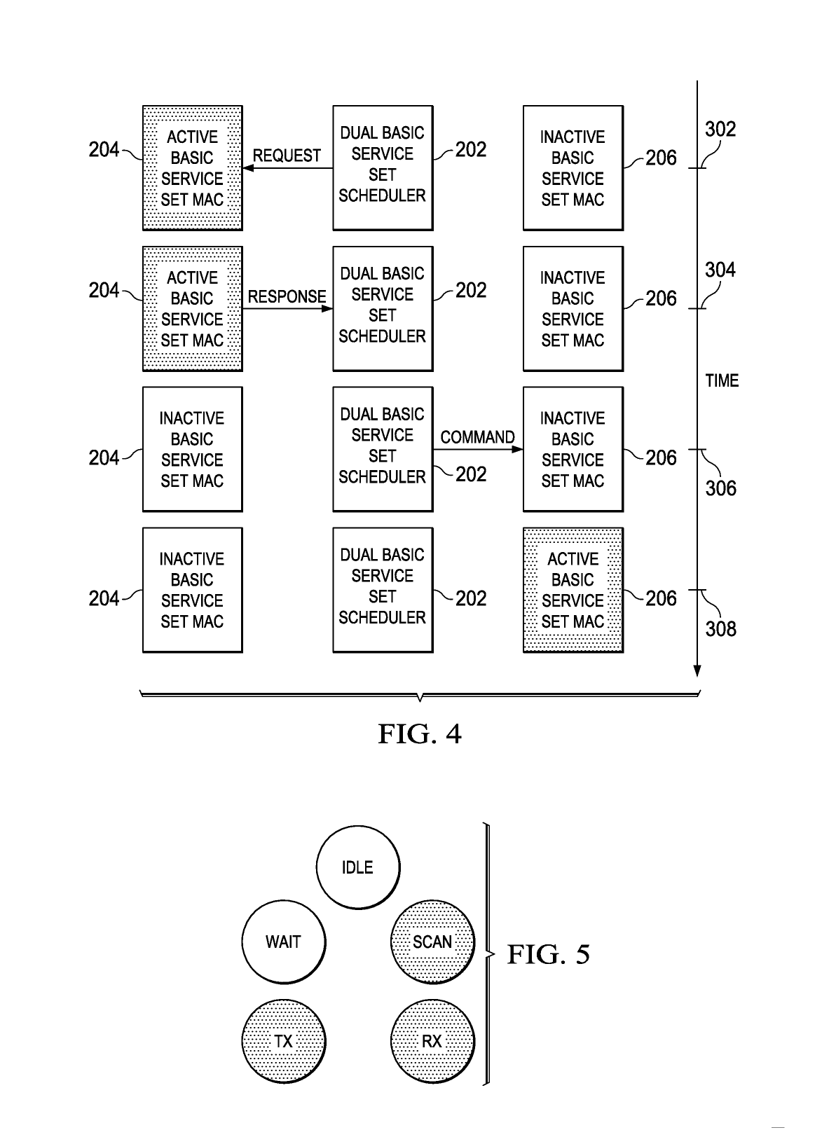

FIG. 4 shows exemplary message flow between the dual BSS scheduler 202 and the MACs 204, 206 in the dual BSS wireless device 102 in accordance with various embodiments. At time 302, MAC 204 is in active BSS state and the MAC 206 is in inactive BSS state. The dual BSS scheduler 202 issues a Dual BSS Request Message to the MAC 204 requesting that the MAC 204 relinquish access to the shared wireless resources and transition from the active BSS state to the inactive BSS state.

At time 304, the MAC 204 provides a Dual BSS Response Message to the dual BSS scheduler 202. The Response Message indicates that the MAC 204 is transitioning from active BSS state to inactive BSS state as requested.

At time 306, the MAC 204 has transitioned from active BSS state to inactive BSS state. The dual BSS scheduler 202, having received the Response Message at time 304, issues a Dual BSS Command Message to the MAC 206 requiring that the MAC 206 immediately transition from the inactive BSS state to the active BSS state. Accordingly, at time 308, the MAC 206 is in the active BSS state, and may access the shared wireless resources.

As shown in FIG. 4, an interval of time separates issuance of the Dual BSS Response Message from issuance of the Dual BSS Request Message. Embodiments of the dual BSS wireless device 102 minimize the interval of time between the messages and optimize use of shared resources and overall network utilization by monitoring the state of the MAC in the active BSS state in conjunction with BSS state changes.

In accordance with the preferred embodiments, if MAC 206 is transitioned to an active state in which the MAC is to operate in a peer-to-peer network, the MAC and scheduler collaborate as explained above to ensure that the MAC is configured for the appropriate regulatory domain in which it is determined to be located. In some embodiments, the determination of the regulatory domain is performed every time a MAC is configured to transition from inactive to active states in which the MAC is to operate in a peer-to-peer network. In other embodiments, the location determination is not made every time a MAC becomes active. For instance, a device 102 may switch between peer-to-peer and infrastructure networks multiples in a short period of time (e.g., multiples per minute). It is not likely that the location of the device 102 will change in such a short period of time between regulatory domains. Thus, in some embodiments, the scheduler 202, or whatever logic makes the location determination and configures the MAC for the appropriate communication parameters, makes such a determination less frequently than every time it changes the active state in a peer-to-peer network. For example, the determination may be made upon the MAC transitioning to the active state as long as at least a predetermined amount of time (e.g., 30 minutes) has passed since the last active state transition occurred.

FIG. 5 shows an exemplary view of activity states of the MAC 204, 206 in the dual BSS wireless device 102 in accordance with various embodiments. The possible activity states of the IEEE 802.11 MAC 204, 206 include idle, wait, transmit, receive, and scan. In the idle state, no data is available for transmission by the MAC 204, 206, and the MAC 204, 206 is awaiting a frame from a higher protocol level.

In the wait state, the MAC 204, 206 is executing a delay prior to execution of an operation scheduled to be performed when the delay expires. For Example, other devices may be communicating via the wireless medium, and the MAC 204, 206 waits a predetermined time for the medium to become idle. In another example, the MAC 204, 206 may delay for a preset time prior to initiating a data transmission or prior to initiating an acknowledgement or response frame for a received packet.

In the transmit state, the MAC 204, 206 uses the medium and other shared resources to transmit a frame. In the receive state, the MAC 204, 206 uses the medium to receive a frame, or is waiting to receive a frame.

In the scan state, the dual BSS wireless device 102 has lost its connection to the wireless network and is searching for a relevant frequency at which to re-establish a connection to the network.

Embodiments of the MACs 204, 206 monitor their internal activity state 210, and reply to the Dual BSS Request Message in accordance with the activity state of the MAC 204, 206 when the Request Message is received. If the MAC 204, 206 is in the active BSS state, and in the idle or wait state when a Dual BSS Request Message is received, then the MAC 204, 206 is not actively using or scheduled to use the shared wireless resources in the near term, and the MAC 204, 206 transitions from the active BSS state to the inactive BSS state immediately after the Dual BSS Request Message is received. The MAC 204, 206 provides the Dual BSS Response Message to the dual BSS scheduler 202 concomitant with the transition from active BSS state to inactive BSS state.

Conversely, if the MAC 204, 206 is in the active BSS state, and in the transmit, receive, or scan state when the Dual BSS Request Message is received, then the MAC 204, 206 is actively using or scheduled to use the shared wireless resources in the near term, and the MAC 204, 206 transitions from the active BSS state to the inactive BSS state after the current operation is complete. The MAC 204, 206 provides the Dual BSS Response Message to the dual BSS scheduler 202 concomitant with the transition from active BSS state to inactive BSS state. Thus, embodiments allow on-going transmissions and receptions to complete prior to relinquishing the shared wireless resources. This may be especially important for quality of service flows, where reducing the packet delay may be critical. Additionally, embodiments reduce the number of retransmissions required when alternating between BSSs by allowing ongoing transmissions and receptions to complete prior to changing BSS state.

Thus, embodiments of the MACs 204, 206 transition from active BSS state to inactive BSS state based on a received Dual BSS Request Message and the MAC state when the Dual BSS Request Message is received. Such embodiments improve network utilization by reducing retransmissions and improve quality of service by reducing packet delay.

Dual BSS wireless devices not basing activity state transitions on MAC state (i.e., embodiments not in accordance with the methods and systems of the present disclosure) may either immediately send a Dual BSS Response Message and enter an inactive state or wait an arbitrary amount of time before sending a Dual BSS Response Message and entering an inactive state. Both options are problematic. If an inactive BSS state is entered during a transmit, receive, or scan MAC activity state, a packet may be lost and/or retransmission may be required that cannot be performed until the BSS is once again activated. On the other hand, arbitrarily delaying the transition to inactive state may unnecessarily increase the amount of time that an inactive BSS waiting to become active remains in the inactive BSS state.

Various components of the wireless device 102, including at least some portions of the dual BSS scheduler 202, and/or the MACs 204, 206 can be implemented using a processor executing software programming that causes the processor to perform the operations described herein. In some embodiments, a processor executing software programming can schedule BSS service time, issue request and/or command messages, provide a response based on MAC state to a request to relinquish access to shared wireless resources, etc. Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, or combinations thereof.

Some embodiments can implement portions of the wireless device 102, including portions of the dual BSS scheduler 202 and/or the MACs 204, 206 using dedicated circuitry (e.g., dedicated circuitry implemented in an integrated circuit). Some embodiments may use a combination of dedicated circuitry and a processor executing suitable software. For example, each MAC 204, 206 may be implemented using a distinct or separate processor or hardware circuitry, or using a shared processor or hardware circuitry. Selection of a hardware or processor/software implementation of embodiments is a design choice based on a variety of factors, such as cost, time to implement, and the ability to incorporate changed or additional functionality in the future.

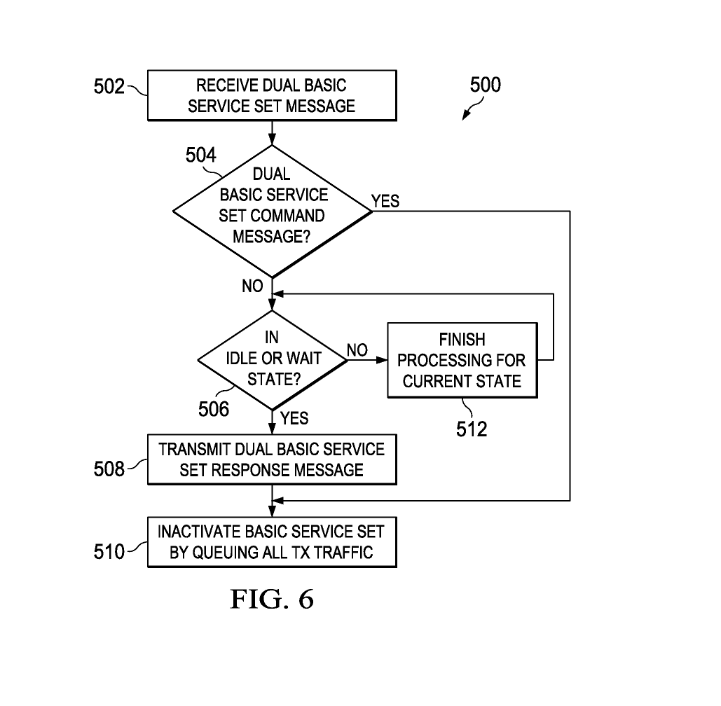

FIG. 6 shows a flow diagram for a method 500 for responding to a Dual BSS Request Message based on MAC state in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 500, as well as other operations described herein, can be implemented by a processor executing instructions stored in a computer readable medium.

In block 502, the BSS 1 MAC 204 is in the active BSS state, and receives a Dual BSS Message. The received Dual BSS message may be Dual BSS Command Message or a Dual BSS Request Message. The Dual BSS Request Message instructs the MAC 204 to transition from active BSS state to inactive BSS state with timing based on MAC state. The Dual BSS Command Message instructs the MAC 204 to immediately transition from active BSS state to inactive BSS state regardless of MAC state. Both messages cause the MAC 204 to relinquish control of the shared wireless resources, allowing the MAC 206 to access the shared wireless resources.

In block 504, the MAC 204 determines whether the received Dual BSS message is a Dual BSS Command Message. If the received Dual BSS message is a Dual BSS Command Message, then the MAC 204 immediately transitions from active BSS state to inactive BSS state in block 510, storing all outgoing data for transmission when the MAC 204 is reactivated.

If, in block 504, the MAC 204 determines that the received Dual BSS message is not a Dual BSS Command Message, but rather is a Dual BSS Request Message, then the MAC 204 checks its current state in block 506. If the MAC 204 is in idle or wait state, then the MAC 204 may immediately transition from active BSS state to inactive BSS state. Consequently, if the MAC 204 is in idle or wait state, then the MAC 204 transmits a Dual BSS Response Message in block 508, and transitions from active BSS state to inactive BSS state in block 510, storing all outgoing data for transmission when the MAC 204 is reactivated.

If in block 506 the MAC 204 is not in idle or wait state, then in block 512 the MAC 204 completes processing for its current state. For example, an ongoing transmission or reception is completed if the MAC 204 is in transmit or receive state when a Dual BSS Request Message is received. When processing for the current state is completed, in block 512, the MAC again checks for idle or wait state in block 506, and transitions to inactive BSS state in blocks 508-510, as described above, when idle or wait state is detected.

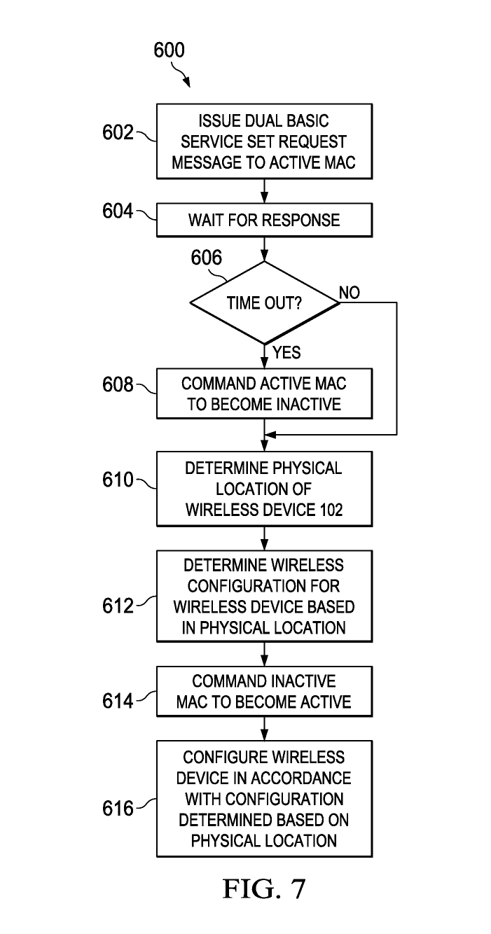

FIG. 7 shows a flow diagram for a method for changing BSS activation states in a dual BSS wireless 102 device in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be implemented by a processor executing instructions stored in a computer readable medium.

In block 602, the MAC 204 is in active BSS state and the MAC 206 is in inactive BSS state. The dual BSS scheduler 202 determines that the activity states of the MACs 204, 206 should be changed, allowing the MAC 206 to become active and access the shared wireless resources. To initiate the state transition, the dual BSS scheduler 202 issues a Dual BSS Request Message to the MAC 204.

In block 604, the dual BSS scheduler 202 waits for a Dual BSS Response Message to be received from the MAC 204. The dual BSS scheduler 202, measures the time from issuance of the Dual BSS Request Message. If, in block 606, the time from issuance of the Dual BSS Request Message exceeds a predetermined maximum wait time without the dual BSS scheduler 202 having received a Dual BSS Response Message from the MAC 204, then the dual BSS scheduler 202 issues a Dual BSS Command Message to the MAC 204 in block 608. The Dual BSS Command Message requires the MAC 204 to immediately transition to the inactive BSS state.

In block 610, the dual BSS scheduler 202, or other logic, determines the physical location of the wireless device 102 using, for example, the PDS subsystem 203 or TZI 205. In block 612, the dual BSS scheduler 202 determines the appropriate configuration to use for the wireless device 102 based on its physical location and the regulatory domain that corresponds to that location as determined by the database 215.

In block 614, the dual BSS scheduler 202 issues a Dual BSS Command Message to the MAC 206. The Dual BSS Command Message issued to the MAC 206 instructs the MAC 206 to immediately transition from the inactive BSS state to the active BSS state. The dual BSS scheduler 202 also issues a command at 616 for the MAC 206 to configure itself based on the regulatory domain determined to be present for the wireless device 102 given its location. This latter command may be a separate command from the Dual BSS Command Message of block 614. In other embodiments, one command can be implemented that performs the same function as that of blocks 614 and 616.

If, in blocks 604-606, the dual BSS scheduler 202 receives a Dual BSS Response Message from the MAC 204 prior to the expiration of the predetermined maximum wait time, then control transitions to block 610 without commanding the active MAC 204 to become inactive.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a first medium access controller (MAC) configured to communicate in at least a first basic service set (BSS) via a first wireless network; and
logic coupled to said first MAC, said logic configured to determine a physical location of said wireless device and implement a communication parameter based on said determined physical location;
wherein said communication parameter being at least one of a frequency, a channel, transmit power, and dynamic frequency selection.

2. The wireless device of claim 1 further comprising a second MAC configured to communicate in a second BSS via a second wireless network and a BSS scheduler configured to time multiplex medium access by the first and second MACs.

3. The wireless device of claim 1, wherein the first wireless network is a peer-to-peer network and the second wireless network is one of an infrastructure network.

4. The wireless device of claim 1 further comprising a satellite-based receiver usable by said logic to determine the physical location.

5. The wireless device of claim 1 further comprising time zone information usable by said logic to estimate the physical location.

6. The wireless device of claim 1 further comprising a database cross-referencing physical locations to communication parameters applicable to such locations.

7. The wireless device of claim 6 wherein said logic accesses said database to determine which communication parameter to implement.

8. A wireless device, comprising:
a first medium access controller (MAC) configured to communicate in at least a first basic service set (BSS) via a first wireless network; and
logic coupled to said first MAC, said logic configured to determine a physical location of said wireless device and implement a communication parameter based on said determined physical location;
wherein said logic determines said physical location based on at least one of a satellite-based receiver and time zone information.

9. The wireless device of claim 8 wherein said communication parameter being at least one of a frequency, a channel, transmit power, and dynamic frequency selection.

10. The wireless device of claim 8 further comprising a database cross-referencing physical locations to communication parameters applicable to such locations.

11. The wireless device of claim 10 wherein said logic accesses said database to determine which communication parameter to implement.

12. The wireless device of claim 8 further comprising a second MAC configured to communicate in a second BSS via a second wireless network and a BSS scheduler configured to time multiplex medium access by the first and second MACs and wherein the first wireless network is a peer-to-peer network and the second wireless network is one of an infrastructure network.

13. A method for a wireless device, comprising:
determining, by logic in the wireless device, a physical location of the wireless device;
determining a wireless configuration for the wireless device based on the physical location; and
configuring the wireless device based on the determined wireless configuration;
wherein the determined wireless configuration includes at least one of frequency, a channel, transmit power, and dynamic frequency selection.

14. The method of claim 13 wherein determining the physical location comprises using a signal from a satellite-based receiver.

15. The method of claim 13 wherein determining the physical location comprises obtaining time zone information.

16. The method of claim 13 further comprising cross-referencing the determined physical location to a communication parameter for the configuration by accessing a database in the wireless device, said database cross-references physical locations to communication parameters applicable to such locations.

17. The method of claim 13 further comprising issuing a state change command to an inactive MAC causing the inactive MAC to transition to an active BSS state, and based on transitioning to the active state, determining the physical location of the wireless device.
